(19) United States
(12) Patent Application Publication
(10) Pub. No.: US 2025/0083530 A1
(43) Pub. Date: Mar. 13, 2025

(54) Rapid Charging Arrangement

(71) Applicant: TDI GREENWAY TECHNOLOGIES LTD., Warwickshire (GB)

(72) Inventors: Paul Salkeld, Warwickshire (GB); Adrian Howson, Warwickshire (GB); Lyle Swan, Warwickshire (GB)

(21) Appl. No.: 18/845,804

(22) PCT Filed: Mar. 13, 2023
(86) PCT No.: PCT/GB2023/050591

§ 371 Date: Sep. 10, 2024

(30) Foreign Application Priority Data
Mar. 11, 2022 (GB) 2203386.4
Dec. 16, 2022 (GB) 2219110.0

(51) Int. Cl. B60L 9/00; B60L 53/31

(52) U.S. Cl. CPC B60L 9/00; B60L 53/31; B60L 2200/26

(57) ABSTRACT

A charging arrangement for a mass transit vehicle, the charging arrangement including at least one conductive portion and a safety arrangement, wherein the at least one conductive portion is configured to deliver charging to a mass transit vehicle at a level of at least 500 kW, and the safety arrangement is configured to activate the conductive portion if a mass transit vehicle is detected.

This specification relates to charging systems for mass transit vehicles. Further, it is a non-exclusive object of this specification to provide a charging system for a mass transit vehicle which enables the vehicle to be charged at a high rate over a short time period.

Mass transit vehicles which are powered by batteries are quiet, efficient, and if appropriate charging is available, do not require onboard generators or other charging apparatus.

Systems to charge mass transit vehicles using overhead power lines or other relatively complex charging infrastructure are known, but such systems do not cater to the continuous operation and start-stop nature of mass transit vehicles. In particular, known systems are not capable of charging the mass transit vehicle at the rate required to continue operation on battery alone. Furthermore, overhead power lines may not be suitable for all locations such as in cities or rural locations where ‘sparking’ or arcing can be a danger.

There are rapid-charging systems which require complex engagement of the mass transit vehicle and the charging arrangement. Such systems include charging ‘feet’ which protrude from the underside of the mass transit vehicle. These charging ‘feet’ are retractable, and the mass transit vehicle must be stopped in a very particular location to allow the ‘feet’ to be deployed and extend to make contact with charging pads. This type of system also requires a safety arrangement which must be deployed whilst charging is in progress, to prevent inadvertent contact with the charging arrangement whilst it is energised.

A mass transit vehicle which is capable of charging simply and rapidly may increase the operating time of the mass transit vehicle, and may also reduce the vehicle's reliance on fossil fuels or complex charging arrangements.

In addition, simple and rapid charging for a mass transit vehicle may increase the range of the vehicle, and may enable the vehicle to travel and provide service to those in areas which have traditionally not been reachable by a mass-transit vehicle.

There is, therefore, a need to provide a simple rapid charging arrangement for a mass transit vehicle which alleviates one or more problems associated with the prior art. It is known from such patents as EP1725424 (Afriat Herve), EP2689953 (Construcciones Aux De Ferrocarriles SA) and US2014239879 (Hohn Ernst Neilsen Madsen) to charging in situ at relatively low charging levels such that the benefits of simple top up or quick charging are not possible along with scope for better battery management curtailed. It will be understood that higher charging rates, particularly in cramped urban environments, lead to greater safety concerns whilst to maximise benefits of charging and battery management independent automation has advantages.

A first aspect provides a charging arrangement for a mass transit vehicle, the charging arrangement including at least one conductive portion and a safety arrangement, wherein the at least one conductive portion is configured to deliver charging to a mass transit vehicle at a level of at least 500 KW, and the safety arrangement is configured to activate the conductive portion if a mass transit vehicle is detected.

Preferably, the charging level is between 500 KW and 750 kW.

Conveniently, the safety arrangement includes a weight sensor to detect the presence of a mass transit vehicle.

Advantageously, the safety arrangement further includes a signalling apparatus configured to connect to the mass transit vehicle, and to receive a signal to identify the mass transit vehicle.

Another aspect provides a section of railway track including a charging arrangement as described herein.

A further aspect provides a concrete slab which includes the charging arrangement as described herein.

A yet further arrangement provides a concrete slab which includes a section of railway track.

Another aspect provides a portion of slab railway track including at least one conductive portion, at least one safety arrangement, and at least one electrical supply arrangement, wherein the or each conductive portion, the or each safety arrangement, and the or each electrical supply arrangement are configured to deliver charging to a mass transit vehicle at a level of at least 500 kW.

A yet further aspect provides a kit comprising at least one conductive portion, at least one safety arrangement, and at least one electrical supply arrangement, wherein the or each conductive portion, the or each safety arrangement, and the or each electrical supply arrangement are configured to deliver charging to a mass transit vehicle at a level of at least 500 kW.

Embodiments of the charging arrangement are described herein, by way of example only with respect to the accompanying drawings in which:—

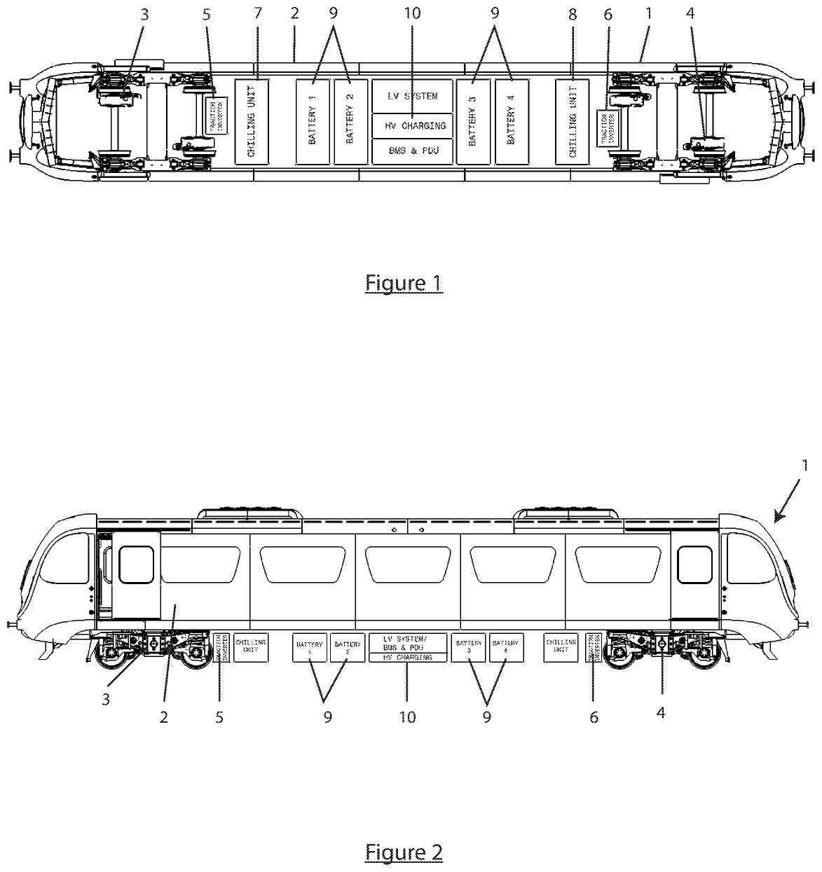

FIG. 1 provides a longitudinal bottom view of a mass transit vehicle;

FIG. 2 is a side view of the vehicle depicted in FIG. 2;

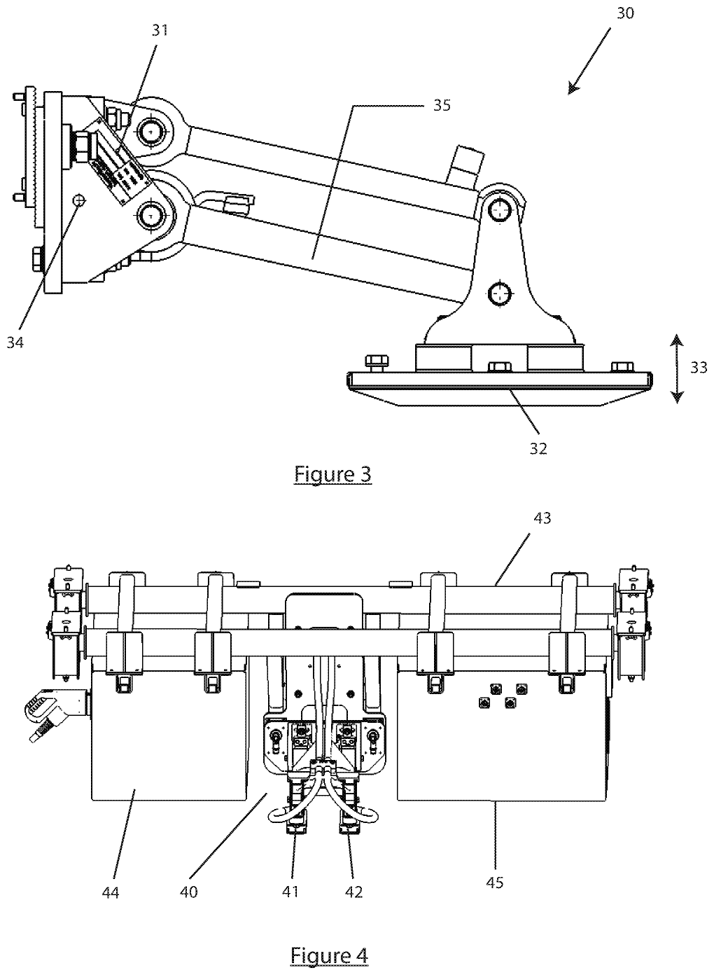

FIG. 3 is a side view of a sprung shoe in accordance with aspects of the present invention;

FIG. 4 is a depiction of the shoe illustrated in FIG. 3 located between panels having power management systems;

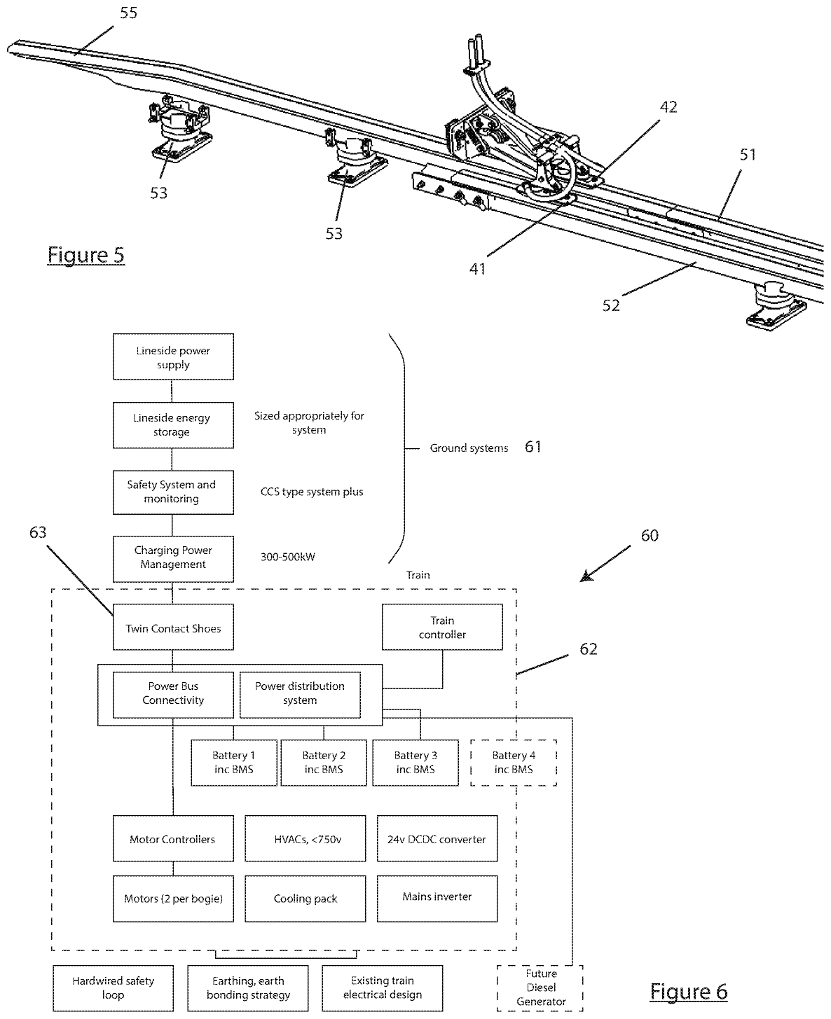

FIG. 5 depicts a charging system and charging rails; and

FIG. 6 provides a schematic depiction of elements of a charging system in accordance with aspects of the present invention.

The charging collector system will normally operate within the tracks of a mass transit system with vehicles and tracks between stops. Two sprung contacts or shoes will contact two conductor rails or sections when the train comes to a halt at a defined location within the station. Sprung shoes are preferable to electively actuated and powered contacts or shoes using pneumatic or hydraulic pressure or motors in order to reduce weight and for reliability reasons (spurious deployment) or if such means of actuation are not available or fail.

Preferably, the shoes can be actuated between a retracted position for vehicle movement at higher speeds and operational position as the train comes to a halt, such actuation would be suitable actuation means, for example a drive or linear motor.

The power rails or conductive sections with which contacts or shoes will make electrical contact in use are typically in a range of 3 to 5 metres in length with a ramp up and down at the ends of each rail to allow the shoes which are usually sprung to make compressive engagement. Such a length will provide sufficient distance for correct location and stopping of the mass transit vehicle in use. Such location may provide driver assistance for location and/or be automated for final location within a few metres either side of the power rail or conductive section.

A safety system surrounds the rails which is both mechanical/physical and electronic. The electronic safety system may include a coded signal which must pass from the vehicle for high current flow across the rail/section and the shoe and so charge the batteries of the vehicle. If the vehicle is in the wrong direction or when contacts is not made then for safety reasons then even with the coded signal it may mean that the power cannot be switched on. In one class of embodiments, the vibration signature of the vehicle on the rail is detected using a sensor mounted to the rail or track, which sensor signals the precise location of the vehicle to the safety system.

The shoes and rails will be mounted off-centre so that with the vehicle in the wrong direction of travel then a dangerous electrical contact and circuit cannot made.

Typically, the optimum location for the contacts or shoes is not on the bogies but instead in the centre of the train. However, the contacts or shoes may also be suspended from the bogies or may be suspended from a frame where space is available in a train vehicle. A simple bracket or frame can be used to mount the shoes in the chosen location, perhaps with an interface mounting plate.

Error! Reference source not found. and FIG. 2 show a mass transit vehicle or train 1 in longitudinal bottom view and side view respectively. Shoe or contact systems must work within the rail gauge whilst the contact rails themselves must not contact any part of the train while running for reasons of avoiding any physical clash as well as electrical safety. For example, the gearboxes are relatively low down as is the obstacle deflector and the contact system must not encroach on the swept area described by these features. The train incorporates a body shell 2 with cabins or compartments (not shown explicitly) for passengers. The train 1 runs on bogeys 3, 4 whilst drive is provided by traction power supplied by suitable means 5, 6 controlled by processors 7, 8. The train 1 has batteries 9 to provide power to motors through the means 5, 6 and under control of the processors 7, 8. Clearly, the batteries will become depleted via use so in accordance with aspects of the present invention as described above a charging unit 10 including sprung shoes or contacts (not shown) are provided to allow rapid and normally substantially within a typical time for a vehicle stop or halt in use. Charging may be full or partial dependent upon that time available and needs of the vehicle such as distance to next stop, nature of gradients and load (passenger number may vary at different times of the day and routes). With scheduled services, which may also be fully or semi-automated, it will be understood that mass transit vehicles on the route can be spaced and speeds adjusted to allow more time for charging of a vehicle as required whilst still maintaining a published time table for the vehicles at each stop on a route.

As illustrated in FIG. 1 and FIG. 2 the elements of the present system as well as the drive mechanism including motors are generally provided below the floor surface of the vehicle 1. Thus, the cabin or compartment is generally open as is desirable with a mass transit vehicle. The location and space envelope for the charging unit 10 is conveniently at a central location between bogies 2, 3 and below floor level and so normally a station platform level.

It is proposed to use a so-called ‘flash’ or in-service charging system which makes use of high current and high voltage over a short time period to provide very rapid charging of batteries.

Flash charging may be enabled by the use of battery types which are suited to rapid charging. One possibility is the use of Lithium Titanate batteries. This type of battery is very safe, very long-lasting, and among the fastest-charging of currently known battery options. Such batteries are compatible with the ‘flash charging’ proposed herein, and thus this type of charging may provide an “invisible” operating strategy wherein a mass transit vehicle takes on charge while in stations and charge is maintained at a near constant level.

The term flash charging is taken to mean a very quick charging strategy, well in advance of ‘fast-charging’ or ‘opportunity charging’ and preferably during an in-service operation. Such use of flash charging may enable the battery power of a mass transit vehicle to be maintained such that the battery level maintained at an optimal level, and may allow seamless 24/7 operation of a mass transit system without the ‘range anxiety’ which afflicts many eV systems.

It is proposed that approximately sixty seconds' worth of charging (such as in a station) will keep the vehicle running for 20 km or more if the charging speed is fast enough.

The fastest presently known road car charging system, employed on high-end electric road vehicles, uses charging rates at 150 KW, while the new Combined Charging System (CCS) is a standard for charging electric vehicles at 350 KW (for two connections).

It is proposed that a battery-powered mass transit vehicle could be charged at in excess of 500 kW.

Presently known systems in the bus industry often employ overhead gantries, whereby a pantograph is lowered onto the top of the pre-positioned bus requiring time and some positional accuracy. Furthermore, such overhead gantries are not currently operating at sufficient power levels for rapid charging.

As mentioned above, there is also a system proposed which requires that a vehicle drive over and connect to ground-based metal pads which are then switched on. These operate at up to 350 KW.

Inductive connection systems are often quoted as a safer option. It is understood, however that the circuitry to generate AC then rectify it leads to heat loss and additional weight, with current maximum charging rates reported to be below 100 KW so not suitable for mass transit vehicles.

It is therefore proposed to provide a simple drive on-drive off connection system for mass transit vehicles, which may include trains, buses, and trams, with the capability to charge at 700 amps or more (at 700 v).

Third rail systems currently used in the rail sector, such as used on the Southern Rail network in the United Kingdom are capable of operating at 1000 amps or more. It is therefore proposed to provide a twin shoe system which uses technology similar to that used in the third rail systems of the rail sector but without a contiguous ‘live’ third rail to drive the train.

The flash charging system described herein in accordance with aspects of the present invention may rely on short lengths (3 to 5 metres) of conductive rail in stations with a ramp-up and a ramp down. It is envisaged that the mass transit vehicle drives over these rails, and in doing so protects the rails from a recess. In driving over the rails, electrical shoes will ride over the rails so the shoes or contacts are deployed to a contact position onto these conductive rails. To prevent erroneous or unsafe charging or electrical supply, the charging supply may not be switched on without the successful completion of an electronic handshake and/or other safety procedures. This may ensure that the contact between mass transit vehicle and flash charging arrangement is verified before the charging is switched on. Clearly, this need to be quick so that a flash charge within the 60 seconds or short time period for a mass transit vehicle to stop at a station on route.

Preferably, the short lengths of conductive rail will be built into a section of slab track, and the flash charging described herein would provide charging to the mass transit vehicle at a level of at least 500 KW, likely between 500 kW and 750 KW, but it is envisaged that such charging may be carried out at a level of around 1 MW.

The slab track section may be constructed as a modular arrangement and may be constructed such that it may be ‘dropped into place’ at a station or stopping point for a mass transit vehicle, that is to say it may be self-contained and include all of the required aspects for the flash charging arrangement to be delivered to the required location and installed, without the need for complex installation of charging arrangements other than of course connection to a suitable source of electrical charging. In addition, the sensing required for safe operation of the flash charging described herein may be pre-installed in the slab track section. In one class of embodiments, the conductive rail is fixed within the slabtrack at a height below the vehicle rails so as to minimise the risk of obstruction.

It is envisaged that at least one safety arrangement will be included in as part of the flash charging arrangement, which may ensure that the conductive rails which deliver the flash charging are not live when there is no mass transit vehicle present. Various safety arrangements are considered, and these include weight sensors, wireless sensors (including RFID or short-range radio, which may be encrypted), a digital handshake protocol which may be transmitted and received through the conductive rails, light sensors, serial communication, or any other suitable method of communication.

The level of current and voltage which is to be supplied for flash charging would be very dangerous if supplied in error to a human or other animal (or indeed to another, incompatible, type of vehicle, so the safety of the flash charging arrangement is an important consideration.

It is envisaged that two independent methods may be used to verify the presence of a mass transit vehicle, and these two methods may, for example, be a weight or position sensing arrangement, for example via the vibration signature of the vehicle to establish whether the mass of the vehicle seeking charging is appropriate (for example—is it the correct vehicle?) and the second method may, for example, be a digital handshake protocol which may be negotiated through the charging contacts or another contact arrangement.

The flash charging arrangement described herein aims to charge batteries easily and quickly so that batteries cease to hamper operability of a mass transit vehicle as compared to a diesel hybrid or a slower-charge battery. This may be delivered in the form of a quickly deployable slab track section.

The level of current and voltage to be supplied is relatively high and may require specially-configured infrastructure to deliver the required level of current during the short time that the flash charging is to be carried out. This may necessitate the use of energy storage solutions which are positioned at or near a flash charging location. Such energy storage solutions may include, for example, batteries, chemical energy storage, mechanical energy storage, or any suitable energy storage arrangement.

The slab track section may be formed of concrete and may be prefabricated. The slab track section may include the conductive rails and the at least one safety arrangement described above.

In use, a mass transit vehicle may move into position at a location which may be a stop, to allow passengers to embark or disembark. In moving into position, as described above, the electrical shoes of the vehicle may ride onto the conductive rails. The required negotiation may then be carried out, to allow the vehicle to flash charge whilst passengers embark and disembark. Once the stop of the mass transit vehicle is complete, the flash charging may be ceased, and the mass transit vehicle may move away, such that the electrical shoes disengage from the conductive rails.

The shoes or contacts should ideally have the following characteristics:

Shoes or Contacts should be Retained within Vehicle in Static Tare and Crush Compression Contact with the Conductive Rail Section

The powers supply should be 700 v, >500 amp nominal, up to 750 amps desirable, without overheating, arcing or welding.

Conductive rail and shoes location is defined on the track and train, ideally so that in the wrong direction the circuit is not made

HV electrical safety ensured including physical and electrical systems

Longevity Consistent with Operation

Actuation (ideally there is no actuation for speed of use, simplicity and lack of hydraulic/pneumatic power). Otherwise, electric actuation will be preferred to avoid a need for a compressor on the train)

Demonstrated immunity to ingress of vegetation and addition of detritus, snow, ice and other environmental conditions

Operating envelope according to design which should include:
Bogie and gearboxes
Obstacle deflector
Battery pack (the battery pack may be redesigned but it will be no deeper than
currently
Crush and tare heights (stationary) included

Compatible with future rail systems or modular slab track

The present invention aims to demonstrate a very high-power drive-on/drive-off charging system which will charge the train while the train is waiting in a station and the passengers are getting on and off.

In one class of embodiments, the charging system is mounted centrally; alternatively they can be offset within the tracks of a single track. The charging system will operate within the tracks as previously proposed and at a height so that it does not interfere with other vehicles operating on the tracks.

The principal components of the charging arrangement are:
A pair of sprung collector contacts or shoes.
A pair of conductor rails fixed into the central region of the track.
A support frame and adjustable mounting plate to suspend the collector contacts or shoes from the hangers in the vehicle and normally centrally.

FIG. 3 shows a side view of a sprung collector shoe or contact arrangement 30 so mitigating the need for actuated shoes (i.e. where hydraulic or pneumatic power is used to raise or lower the contacts). The arrangement 30 has springs 31 so that contacts or shoes 32 can move up and down in the direction of arrowheads 33 to contact a conductive section or rail (not shown). The shoes 32 are connected to a mounting 34 such that the arrangement 30 has a centre of pivot 35. In the illustrated embodiment, the arrangement 30 possesses the following characteristics:
1. The shoes will still make adequate contact with the rails even in the static tare condition with new wheels. The height difference between Tare and Crush loading is 56 mm (primary) plus 3 mm (secondary suspension) which the contact shoes must accommodate.
2. The contact shoes will remain within the vehicle except in conditions of crush loading the positive shoe will protrude to one side of the 4^{th} rail allowance because the collector shoes are mounted non-centrally to avoid issues with polarity. It would be possible to move the collector shoes into the designated space.

FIG. 4 illustrates contacts or shoes 41, 42 of a sprung contact arrangement 40 (similar to 30 in FIG. 3). The arrangement is secured to a frame 43 across a vehicle. Other power elements 44, 45 such as batteries are either side of the arrangement 40 so in use in addition to the safety control features described above in that electrical flow only occurs in a safe condition. These elements 44, 45 provide a physical obstruction and barrier to the dangerous electrical flow between the shoes 41, 42 and the conductive rails (not shown in FIG. 4).

Conductive rails 51, 52 as shown in FIG. 5 have ramps 55 at either end of a 5 metre rail contact section which the train will cover before they become ‘live’ under controlled circumstances. The rails 51, 52 will be mounted on isolators 53 onto the rail sleepers (not shown). Collector contacts or shoes 41, 42 will respectively ride up the ramps 55 and charge will start to flow when the right safety conditions have been met. The ramps 55 will typically be such that a train my ride over them at 30 mph (higher speeds are possible) conductive to a vehicle entering a station or stop.

In a preferred embodiment, the location of the rails 51, 52 is important for a number of reasons:
1. The rails will be positioned high so that the contact shoes 41, 42 in their coordinated location are exposed as little as possible to impact from debris on the track that is not cleared by an obstacle deflector.
2. The rails will be nominally 5 metres in length with a ramp 55 up and down at the ends, meaning a total length of 15 m. The rails 51, 52 will be mounted on isolators 53 and bolted to the sleepers which may also be non-electrically conductive. The rails 51, 52 will typically not be shrouded in any way on the understanding that this causes attention to be drawn towards them and the possibility of damage resulting from a failure of the shroud or debris collecting within the shroud. The rails 51, 52 in any event will only be powered when the train is over the rails under strictly controlled circumstances.
3. The shoes 41, 42 and rails 55 will be mounted off-centre so that if the train is travelling in the wrong direction of travel a dangerous circuit is not possible.
4. The rails 55 may be connected to a battery buffer which will store up the energy for charging into the train rather than making a large and sudden demand from the local power grid.

A simple frame 43 (FIG. 4) supports the shoes 41, 42 but the contacts could be incorporated into a comprehensive power package.

The frame 43 also provides the required adjustment for worn or reprofiled wheels. The frame 43 is preferably mounted in the location previously occupied by a battery or fuel tank in hybrid drive systems.

The charging system forms the central core of a whole charging system which effectively connects the batteries to the power grid.

The whole system can be described by Error! Reference source not found. This system is specified for each installation and will encompass the risks associated with charging the batteries at high speed. The list of risks include:
Components required to handle in excess of 500 kW
Passenger and pedestrian safety through suitable control systems.
Minimal disruption to the national grid by means of intermediate batteries.
Management of the on-board systems by means of the train's control systems

As shown in FIG. 6 the charging arrangement 60 comprises a ground or conductive rail side or system 61 and a train or power contact system 62. The electrical charge flow is between the shoes 63 and the conductive rails (not shown). Each system 61, 62 will have various control elements as depicted in FIG. 6 along with other elements to render the whole system safe and specifically controlled for rapid flash charging of the batteries. It will be noted to the train may also include a electrical generator such as a diesel generator 64 to provide power if necessary for a train where not all stations or stops have conductive rails in accordance with aspects of the present invention or power is lost between stations in a recovery mode.

It will be appreciated with a high-power train-mounted battery solution the present invention can be considered as a Lineside Charging System (LCS). Several such systems (LCS) could be installed in some or all of the stations on the route.

These chargers will connect automatically to the train to charge the batteries while the passengers are getting on and off. A relatively small duration of charging in each station will mean that the train battery ‘state of charge’ can be maintained at a reasonably constant level throughout the day and the train schedule is not interrupted by the need to stop for charging.

Lineside charging systems (LCS) can be described in terms of the two main functional blocks which are the 1) provision of electrical power and 2) the safety system.

The electrical power can either be provided directly from the established power grid such as the UK national grid using a transformer or by means of a battery which stores up energy over a longer period and is then able to ‘dump’ charge the vehicle at appropriate moments.
Direct provision of lineside power could be difficult to provide and might cause disturbance to the local power systems. However, this is a requirement that is common to the rail industry and will not be exceptional but could be an expensive solution particularly if a retro fit to existing infrastructure.
It might be more economically attractive to use a separate lineside charging battery where (e.g. in rural locations) a direct charge system might be expensive or unsafe to install. Typically, this battery would power a DCDC converter to create the voltage needed to ‘drive’ the current (and therefore power) into the vehicle battery. The lineside battery would then be charged by a low-level electrical supply such as 3-phase on a continuous and lower current basis. The DCDC converter reduces the size of the battery required to provide the voltage required.
Lithium titanate batteries are very good providers of line side energy since their internal resistance is low. This means that a lineside battery-based charging system equipped with Lithium Titanate batteries can deliver high power charging from a relatively small battery package.

In addition to the provision of power is the need for a suitable safety system. The CCS (combined charging system) or CHAdeMO are examples of commercial standards which if applied, mean that power is not applied to the charging system unless it is entirely safe to do so. For example, when the train is not positioned over the rails, the charging rails should not be energised in case animals or people step onto them. Furthermore, even if the train is over the charging rails, they should not power up in the presence of flood water or snow for example, which could be extremely dangerous at the voltage levels intended for adequate charging in accordance with aspects of the present invention. One advantage of sending the safety/charging signal through the rails (Powerline Communication PLC) is that if a communication contact or RF method is used that a user might not be unaware that there is an issue with the rails. The PLC approach, as well as saving cost of a potential additional rail, is intrinsically secure.

Aspects of the present invention provide a charging arrangement which is automated and mostly autonomous in that charging is in bursts at relative high charging rates, typically greater than 500 MV. The regime is little and often so that a short burst of say 10 to 15 seconds of charge is possible in the interval of a passenger vehicle stop. The high charging rate allows such bursts within an automation period which comprises time for a safety arrangement to determine a vehicle is present, in position and at least a basic knowledge of vehicle type determined but advantageously and additionally current battery charge level, planned route, vehicle equipment condition (whether lights such as headlights or cabin illumination are operative), expected route conditions and occupancy (current or expected), whether the next charging station is operative such that extra charge at the current station is required to reach the next operative charging arrangement at a station on the route. It will also be appreciated for the most part charging must be within the time that is available at a stop station, typically one minute or less, rather than the period at a stop station dictated by the time necessary for charging to a set level or dependent upon driver input either to reach a set level of charge and/or to maintain a schedule. Such variations inherently will have consequences with a scheduled service with vehicles expected on time at various stops and especially timing stop on a route.

The safety arrangement in accordance with aspects of the present invention as indicated is automated so that the charging regime desired and normally best for the battery or batteries is provided. The high charge rate is in bursts but not necessarily the same at each stop. For battery management and life typically the charge levels should remain within operating bands rather than achieve an operationally consistent charge level. The charge level may oscillate within the desired levels for a vehicle and use of burst charging at high charging rates as compared to prior trickle or low-level charging allows elective charging dependent upon desired operation performance but within the schedule stops of a vehicle.

It will be appreciated that a vehicle can travel the same route or different routes with inclines, descents, traffic control with other vehicles which may cause acceleration, deceleration and stops other than at stations. There will be variations in power demands so variation on charge depletion in the batteries within the vehicle. With aspects of the present invention the route is known for a rail vehicle particularly a light rail vehicle or tram so the charging at different stations can be different to achieve desired and normally optimisation of battery life and performance. The burst charging may be longer or shorter or at a different charging rate dependent on the needs of the known route but also by feedback from previous vehicles who have performed the next leg to the next station. It will be understood that initial knowledge of the route can program charging at each station necessary for desired performance either from a basis regime for that known route possibly adapted with some other knowledge such as weather conditions and expected occupancy but actual results with a prior vehicle in terms of battery management can be adapted from the expected regime for that known route so for example a normal regime for a route can be established but this can be specifically adjusted in view of expected events such a football match concert so that there will be a greater passenger load or unexpected events such as alternative forms of transport being unavailable such as the previous vehicle being taken out of service so the subsequent vehicle carries more passengers so there will be more drain on the battery. Furthermore, by aspects of the present invention by automation battery management can be such that the additional charging required can be spread over several charging stations or arrangements rather than one. Such auto learning of a route whether temporary or not will allow better battery management but also vehicle to vehicle comparison and in particular battery and running gear performance, if one vehicle consistently needs more charge than other vehicles than at a base level this may indicate a problem with the battery or running gear so maintenance inspection should be flagged or that vehicle is performing a heavier duty cycle due to the time of day it is operated so switching vehicles usage period to spread heavy workload advisable.

A particular feature of aspects of the present invention is the use of burst charging. This allows more convenient charging within typical vehicle halt or stop times and normally independent of operator such as driver function. The objective is to provide charging which is almost independent of operator/driver functions so the driver can still drive the vehicle in terms of stop, start, acceleration etc. and would be substantially unaware of charging or not. In such circumstances the driver will not be incumbered by additional controls for charging and/or interaction with driver controls will be avoided which inherently will affect and vary charging time. It will be appreciated that burst charging may be achieved by a number of means including direct charging at the high level, use of batteries to charge at that level, use of step up and/or step down transformers, capacitors etc. or combinations at the same station or along a route Thus, the burst charge may be different at each station so aspects of the present invention through automation allow better battery management suited to the route, vehicle and conditions, both expected and actual occurring as seen by previous vehicles as well as for battery life. The driver or automated driver mechanism in such circumstances is provided with a power drive system of a known performance within a band or range rather than the driver or automated mechanism operating the vehicle in an attempt to keep the power drive system and especially the battery within certain ranges. The use of burst charging allows a wider range of charging sources, battery management specified for known routes rather than use of continuous, steady generally lower charging levels. It will also be understood that burst charging allow greater charging flexibility in that devices such as batteries, capacitors and transformer may themselves have refresh times for recharging or overheating so elective choice of burst charging will allow a vehicle to skip charging at one station which has been depleted by a previous vehicle and hasn't recovered but on the basis that a burst charge will be available at the next station whilst the battery charging level remains within desired operational band ranges for better battery management.

While the invention has been illustrated and described in detail in the drawings and preceding description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. Each feature of the disclosed embodiments may be replaced by alternative features serving the same, equivalent or similar purpose, unless stated otherwise. Therefore, unless stated otherwise, each feature disclosed is one example of a generic series of equivalent or similar features.

In the claims, the word “comprising” does not exclude other elements or steps, and the indefinite article “a” or “an” does not exclude a plurality. Any reference signs in the claims should not be construed as limiting the scope.

1. A charging arrangement for a mass transit vehicle, the charging arrangement including at least one conductive portion and a safety arrangement, wherein:
the at least one conductive portion is configured to deliver charging to a mass transit vehicle at a level of at least 500 kW; and
the safety arrangement is configured to activate the conductive portion if a mass transit vehicle is detected.

2. The charging arrangement of claim 1, wherein the charging level is between 500 KW and 750 kW.

3. The charging arrangement of claim 1 or claim 2, wherein the safety arrangement includes a weight sensor to detect the presence of a mass transit vehicle.

4. The charging arrangement of claim 1 or claim 2, wherein the safety arrangement includes a sensor mounted to the track to monitor the vibration signature of the vehicle to detect the presence of a mass transit vehicle.

5. The charging arrangement of claim 3 or claim 4, wherein the safety arrangement further includes a signalling apparatus configured to connect to the mass transit vehicle, and to receive a signal to identify the mass transit vehicle.

6. An arrangement as claimed in any preceding claim wherein the conductive portion is a lateral section for location below a vehicle and configured to receive a shoe for electrical contact whereby the safety arrangement activates the conductive portion when the contact is made between the conductive portion and the shoe.

7. An arrangement as claimed in claim 6 wherein lateral section is 3 to 5 metres in length to provide a range for contact with the retractable shoe.

8. An arrangement as claimed in claim 6 or claim 7 in which the ends of the lateral section has a ramp.

9. An arrangement as claimed in any of claims 6 to 8 in which the arrangement includes two lateral sections as rails and there is a shoe for each lateral section.

10. An arrangement as claimed in any of claims 6 to 9 wherein the shoe is sprung into contact with the conductive section.

11. A section of railway track including the charging arrangement of any one of claims 1 to 10.

12. A concrete slab which includes the charging arrangement of any one of claims 1 to 10.

13. A concrete slab which includes the section of railway track of claim 12.

14. A portion of slab railway track including at least one conductive portion, at least one safety arrangement, and at least one electrical supply arrangement, wherein the or each conductive portion, the or each safety arrangement, and the or each electrical supply arrangement are configured to deliver charging to a mass transit vehicle at a level of at least 500 kW.

15. A kit comprising at least one conductive portion, at least one safety arrangement, and at least one electrical supply arrangement, wherein the or each conductive portion, the or each safety arrangement, and the or each electrical supply arrangement are configured to deliver charging to a mass transit vehicle at a level of at least 500 kW.

16. A kit as claimed in claim 15 wherein the electrical supply arrangement is provided by a lineside charging system further comprising a battery array and safety arrangement control the electrical supply.
